(19) United States
(12) Patent Application Publication
(10) Pub. No.: US 2026/0110097 A1
(43) Pub. Date: Apr. 23, 2026

(54) System and Method of Applying a Conductive and Transparent Coating on Non-Metallic Surfaces

(71) Applicant: NaugaNeedles, Louisville, KY (US)

(72) Inventors: Mehdi Mohammad Yazdanpanah, Louisville, KY (US); Ramin Yazdanpanah, Evanston, IL (US); Robert Warren Cohn, Louisville, KY (US); John Neal Randall, Richardson, TX (US); Mohammad Reza Sadeghi, Tehran (IR); Zoya Yazdanpanah, Potomac, MD (US)

(21) Appl. No.: 19/367,581

(22) Filed: Oct. 23, 2025

Related U.S. Application Data
(63) Continuation-in-part of application No. 19/352,156, filed on Oct. 7, 2025.
(60) Provisional application No. 63/711,124, filed on Oct. 23, 2024.

(51) Int. Cl. C23C 30/00; B05C 1/02; B05C 5/02

(52) U.S. Cl. CPC C23C 30/00; B05C 1/02; B05C 5/0208

(57) ABSTRACT

A method of forming a conductive “Ag₂Ga+zGa” based coating on various materials, forming a flexible and optionally transparent film with excellent electrical conductivity and mechanical compliance. The film is formed by depositing a layer of Ag₂Ga+zGa amalgam (i.e., z ranges from 1 to 5 depending on the application) near room temperature, followed by curing or annealing the substrate. The conductive coating exhibits mechanical flexibility, electrical conductivity, and adhesion to the substrate sufficient to permit bending or rolling of the coated surface without degradation of conductivity. Further, conductive coating may be used as temporary, removable, or rewritable conductive paths. Moreover, under controlled annealing or vibrational treatment, the coating can become semi-transparent, forming transparent conductive layers useful for displays, sensors, solar cells, or smart surfaces.

The current application is a continuation-in-part (CIP) application of the U.S. non-provisional application Ser. No. 19/352,156 filed on Oct. 7, 2025. The U.S. non-provisional application Ser. No. 19/352,156 claims a priority to the U.S. provisional patent application Ser. No. 63/711,124 filed on Oct. 23, 2024.

### FIELD OF THE INVENTION

The present invention generally relates to conductive and transparent coatings and films comprising silver-gallium (i.e., Ag₂Ga+zGa, wherein z is between 1 and 5) alloys and their derivatives. More particularly, the present invention concerns applying AgₓGa coatings to non-metallic substrates (e.g., plastics, Teflon, ceramic graphite, concrete, and asphalt) to produce flexible, conductive, and optionally transparent layers suitable for temporary and permanent electrical contact, flexible circuits, transparent conductive films, soldering, and wiring materials.

### BACKGROUND OF THE INVENTION

In many industries, durable, conductive, and oxidation-resistant coatings are essential to enhance the longevity and performance of materials exposed to harsh environmental conditions. Metals are particularly susceptible to oxidation and degradation when exposed to high temperatures, or reactive chemicals, which can compromise their electrical conductivity, structural integrity, and appearance. Applications ranging from electronics and industrial machinery to jewelry demand materials that can withstand such conditions. Traditional methods of preventing oxidation, such as plating and protective coatings, often degrade over time or fail to endure extreme temperatures. Furthermore, these coatings may not provide sufficient electrical conductivity for electronic components or solar cell batteries.

Modern electronic systems increasingly rely on lightweight, flexible adherable, and sometime transparent conductive materials that can be applied to non-metallic substrates such as polymers, composites, and ceramics. Traditional conductors (e.g., copper, aluminum) offer high electrical performance but are limited by their rigidity, their oxidation susceptibility, and their transparency limitation with flexible or non-metallic surfaces. Traditional transparent conductors (e.g., Indium Tin Oxide (ITO)) are limited by their electrical conductivity, which is about 1000 times less than metallic conductors (e.g., silver, copper).

Recent advances in printed and flexible electronics have introduced conductive inks based on silver nanoparticles, carbon nanotubes, and graphene, yet these materials typically exhibit inferior conductivity, complex processing requirements, and weak adhesion to certain substrates. Furthermore, most metallic conductors rapidly oxidize, leading to loss of conductivity and degradation under environmental exposure.

Therefore, an objective of the present invention is to provide users with a system and method for application of Ag₂Ga+zGa coatings to different materials including non-metallic surfaces, enabling conductive and transparent films on materials such as plastic, Teflon, graphite, glass, silicon, polymer, ceramic, concrete, and asphalt.

When applied to polymeric films or composite substrates, the Ag₂Ga+zGa coating adheres strongly and forms a continuous conductive layer without requiring high end coating machinery. Moreover, under controlled annealing or vibrational treatment, the coating can become semi-transparent, forming transparent conductive layers useful for collar cells, displays, sensors, or smart surfaces.

Additionally, in electronic assemblies containing sub-micron copper films, such as microelectronic circuits and flexible interconnects, applying a thin AgₓGa coating (i.e., wherein x is between 0.1 and 2) can protect the copper layer from oxidation and improve its surface conductivity. This combination of thin copper and AgₓGa coatings enables high-performance, flexible, and transparent electrical structures that are both oxidation-resistant and mechanically durable.

Additionally, in electronic circuit repairs, silver-gallium amalgam can be used as soldering material to provide electrical connectivity between multiple points in a circuit.

### SUMMARY OF THE INVENTION

The present invention is a method for producing a conductive “Ag₂Ga+excess gallium” based coating on various materials, forming a flexible and optionally transparent film with excellent electrical conductivity and mechanical compliance. The film is formed by depositing a layer of Ag₂Ga+zGa amalgam, wherein z ranges from 1 to 5 depending on the application near room temperature in ambient condition, followed by curing or annealing the substrate up to 500 degrees Celsius (° C.) to form a network of Ag₂Ga nanowires imbedded in a gallium oxide transparent film. The coating exhibits mechanical flexibility, electrical conductivity, ease of coating using traditional brushing or spraying, and sufficient adhesion to the substrate to permit bending or rolling of the coated surface without degradation of conductivity. Moreover, under controlled annealing or vibrational treatment, the coating can become semi-transparent, forming transparent conductive layers useful for collar cells, displays, sensors, or smart surfaces.

### BRIEF DESCRIPTION OF THE DRAWINGS

FIG. 1 is a block diagram illustrating the alternate system of the present invention.

FIG. 2 is a flowchart illustrating an overall process for the alternate method of the present invention.

FIG. 3 is a schematic representation of a non-transparent film formation before annealing of Ag₂Ga+excess Ga onto an exterior surface of the treatable apparatus.

FIG. 4 is a schematic representation of a transparent film formation after annealing of Ag₂Ga+excess Ga onto an exterior surface of the treatable apparatus.

FIG. 5 is a schematic representation of coating a silver gallium film over a flexible substrate.

FIG. 6 is a schematic representation of a rolled conductive material, that has multiple layers of silver gallium coating.

FIG. 7 is a schematic representation, wherein silver gallium coating acts as a conductive paint between point A and B over a non-conductive surface.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is it to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one” but does not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

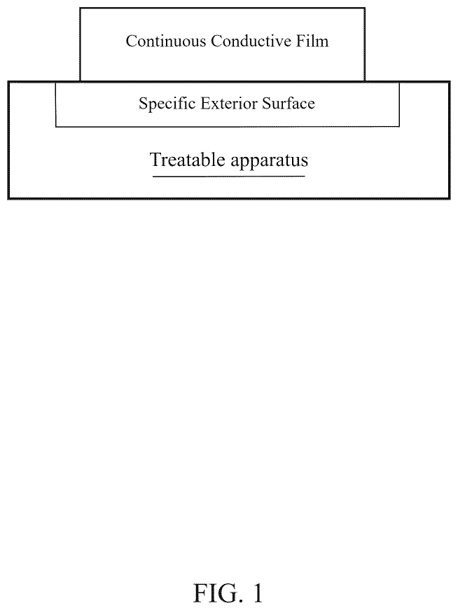

The system used to execute an alternate method of the present invention includes a treatable apparatus (Step E), wherein the treatable apparatus is made of a specific material. The treatable apparatus is a device or surface over which the conductive coating has to be formed. As FIG. 1 shows the substrate as a flat surface, the present invention allows for the same method to coat other surface shapes, including but not limited to cylindrical shapes, tubular shapes, flat surfaces, and corrugated surfaces. In the preferred embodiment, the specific material is a non-metallic material, which can be, but is not limited to, plastics, Teflon, graphite, ceramic, glass, silicon, concrete, and asphalt. More specifically, the specific material may be opaque, translucent, or transparent. If the specific material is opaque, the specific material can be, but is not limited to, polymer, carbon, wood, graphite, ceramic, concrete, asphalt, glass, or silicon. Further, if the specific material is transparent or translucent, the specific material can be, but is not limited to, glass or polymer.

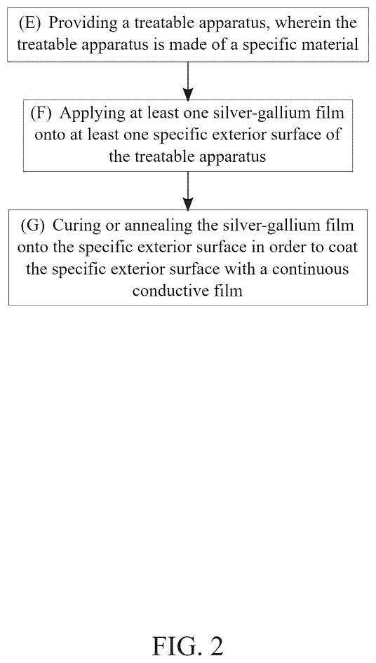

As can be seen in FIG. 2, an overall process for this alternate method allows the present invention to efficiently and effectively apply an external surface of an object with a conductive coating. The overall process begins by applying at least one silver-gallium film onto at least one specific exterior surface of the treatable apparatus (Step F). The at least one specific exterior surface is a single portion, multiple portions, or the entirety of the treatable apparatus, wherein the conductive coating is being formed. In the preferred embodiment, a chemical composition of the silver-gallium film is Ag₂Ga+zGa, wherein zGa is an excess in gallium, and wherein a value of z is between a range of 1 to 5. In other words, the silver-gallium film is formed by depositing a layer of Ag₂Ga nano-crystalline and micro-crystalline wires with an excess of gallium at normal temperature and pressure (NTP) onto the specific exterior surface. Further, Step F may be performed with a coating process that can be, but is not limited to, brushing, rolling, spraying, evaporation, sputtering, or electrochemical deposition. As a first example, the deposition of Ag₂Ga+zGa is performed using a painting brush on the specific exterior surface. As a second example, Ag₂Ga+zGa is deposited using a commercially available spray with a modified heating reservoir to heat up the desired temperature. As a third example, the coating of Ag₂Ga+zGa is using one or more rollers, wherein the treatable apparatus is passed in between multiple spongy rollers coated with Ag₂Ga+zGa. A supply of Ag₂Ga+zGa is constantly pumped into the roller(s) from a reservoir to keep the roller(s) covered with Ag₂Ga+zGa. By adjusting the flow for the supply of Ag₂Ga+zGa into the roller(s), the conductive coating thickness can be controlled to form a uniform coating on the specific exterior surface of the treatable apparatus (i.e., a surface of a substrate).

The overall process continues by curing or annealing the silver-gallium film onto the specific exterior surface in order to coat the specific exterior surface with a continuous conductive film (Step G). Curing is a process that induces a chemical reaction or a series of reactions that lead to the formation of a cross-linked network within a material. Annealing is a heat treatment process that changes the physical and sometimes also the chemical properties of a material to increase ductility and reduce the hardness to make it more workable. The annealing process requires the material above its recrystallization temperature for a set amount of time before cooling. Annealing can occur in air or vacuum. Annealing at extreme temperatures (i.e., above the melting point of the substrate) requires a vacuum to prevent oxidation. The overall process concludes by resulting in a film that exhibits mechanical flexibility, electrical conductivity, and adhesion to the substrate sufficient to permit bending or rolling of the coated surface without degradation of conductivity.

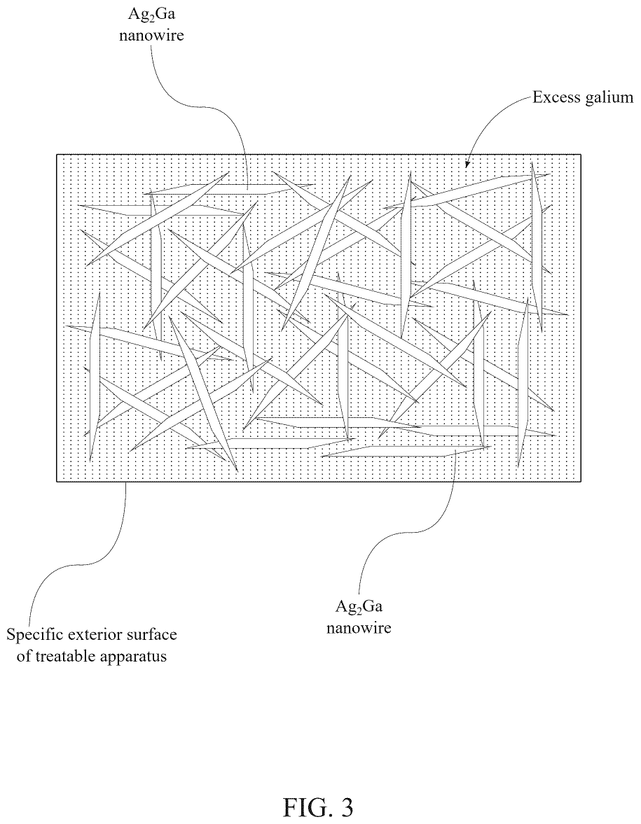

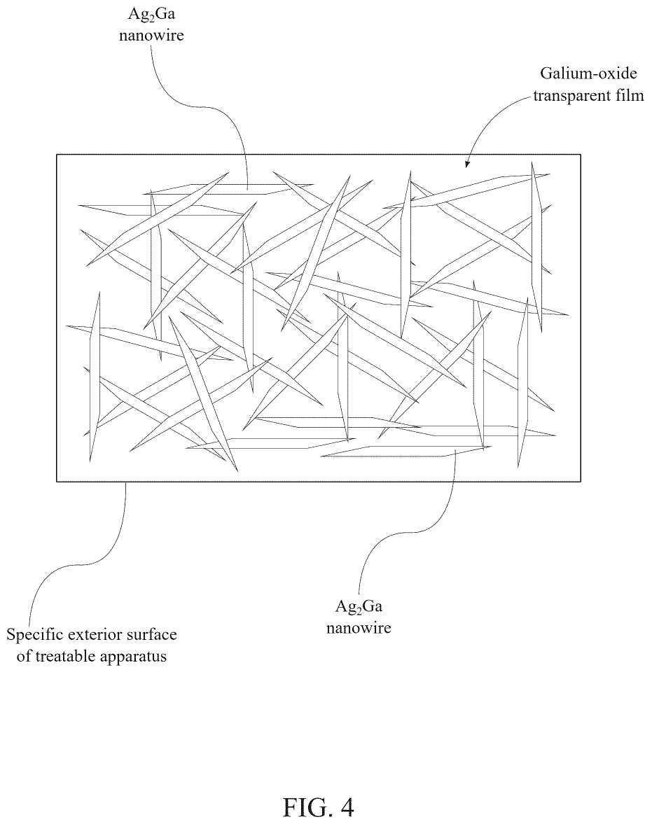

An application of Ag₂Ga+zGa conductive coating is to coat non-conductive, transparent substrates (e.g., plastic, glass) to make them conductive while maintaining transparency. By applying thinner layers of Ag₂Ga+zGa on transparent materials (e.g., glass, polymer), semi-transparent conductive coatings can be produced, suitable for solar cell technology. An annealing step is required to enhance the layer's transparency. The Ag₂Ga+xGa layer is annealed at up to 500° C. on a hotplate, causing Ag₂Ga nano-crystalline and micro-crystalline structures to form interconnected metallic islands, which provide conductivity, while transparent gallium oxide islands form around them as shown in FIG. 3 and FIG. 4.

More specifically, by annealing treatment of Ag₂Ga+zGa in air, excess gallium reacts with oxygen according to the following formula:

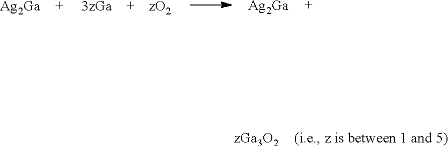

This combination creates a semi-transparent conductive film that is approximately 1000 times more conductive than Indium Tin Oxide (ITO) films currently used in the industry.

Another application of Ag₂Ga+zGa is to coat glass substrates to create conductive, semi-transparent glass products. Ag₂Ga+zGa (i.e., the value of z is 1) has been applied to several glass slides, which are then immersed in dilute Hydrochloric Acid (HCl 1N) for a few minutes. The HCl selectively removes excess gallium, leaving a transparent conductive Ag₂Ga nanowire network with 86% of the conductivity of a similar silver film. To that end, the film is immersed in the HCl bath and air-dried, resulting in a semi-transparent nanowire network. For added durability, drying can be performed inside a critical point dryer to prevent film damage.

When applied to polymeric films or composite substrates, the Ag₂Ga+zGa coating adheres strongly and forms a continuous conductive layer without requiring high-temperature annealing. Moreover, under controlled annealing or vibrational treatment, the coating can become semi-transparent, forming transparent conductive layers useful for displays, sensors, or smart surfaces.

The alternate method of the present invention can also be used to form a continuous conductive film that is transparent as well. As a first example, the specific material is opaque, then a continuous transparent conductive film allows the specific exterior surface to be seen through the continuous transparent conductive film. As a second example, if the specific material is translucent or transparent, then a continuous transparent conductive film allows visible light to be seen through the continuous transparent conductive film and the treatable apparatus. Thus, a thickness of the silver-gallium film can be decreased during Step F in order to increase a transparency of the continuous conductive film (i.e., a continuous transparent conductive film).

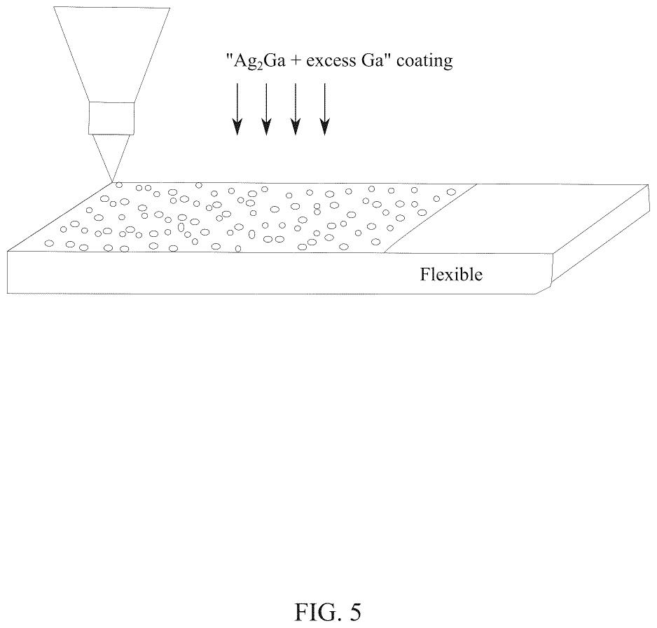

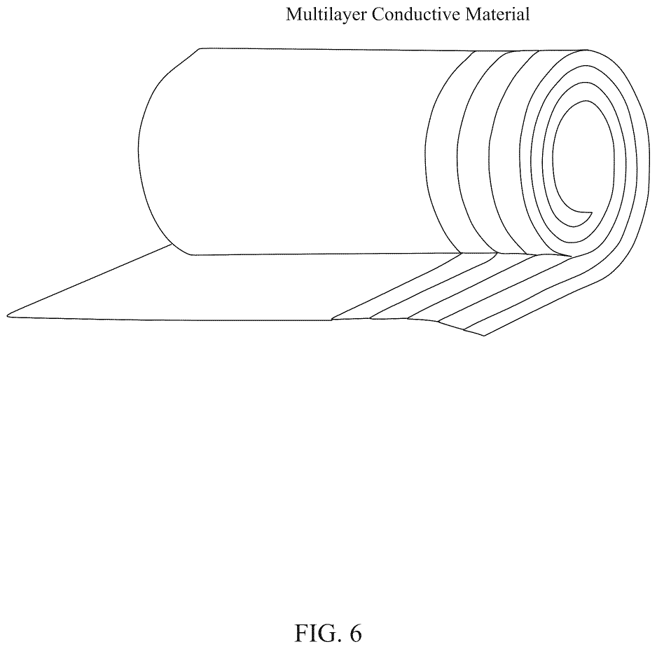

In reference to FIG. 5 and FIG. 6, the conductive silver gallium layer is applied to a non-conductive flexible substrate in multiple stacked or rolled layers to form a flexible multi-layer conductor suitable for use as a wiring material capable of transmitting electrical signals. Accordingly, a sub-process of the alternate method comprises the step of executing a plurality of iterations for Step F, wherein the at least one silver-gallium film is a plurality of silver-gallium films, and wherein the plurality of silver-gallium films is layered onto each other during plurality of iterations for Step F. Further, the silver-gallium coating can be applied using a roll-to-roll or spray-on process to produce flexible conductive sheets for large-scale manufacturing.

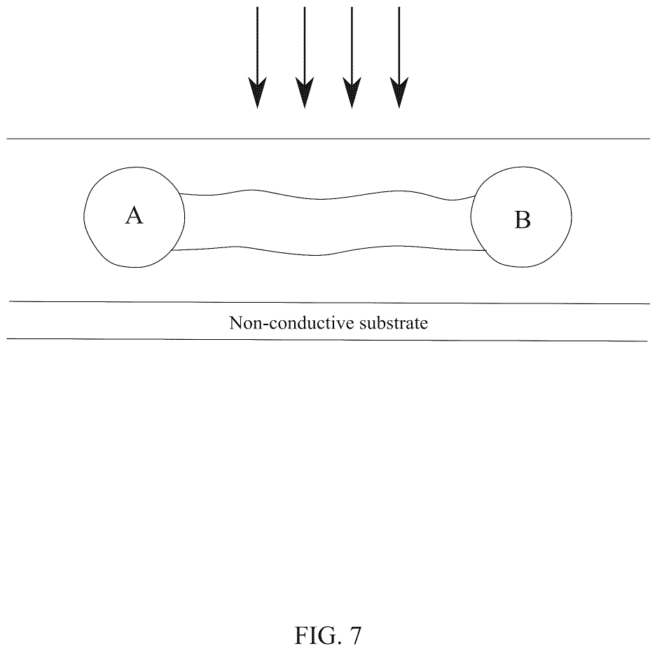

In reference to FIG. 7, if the treatable apparatus is a non-metallic substrate comprising polymer, silicon, glass, graphite, graphene, ceramic, or concrete, the silver-gallium conductive layer acts as a temporary conductive interface between two electrical elements (e.g., an element A and an element B) and can be removed or replaced after completion of electrical work.

It should be noted that the at least one physical property of the protective coating is modified by adjusting at least one of process parameters during Steps F and G, wherein the process parameter can be, but is not limited to, the value of z in Ag₂Ga+zGa, a thickness of the silver-gallium film, a kind of application method of the silver-gallium film during Step F, an annealing duration, an annealing temperature, and a combination thereof. In other words, the coating thickness and curing conditions may be controlled to produce an optically transparent and electrically conductive film. For example, the thickness of the silver-gallium film is less than 500 nanometers (nm), conductive film exhibits electrical conductivity greater than 10⁷ S/m and optical transparency greater than 80% in the visible spectrum.

Thus, in summary the above alternate method for producing a conductive Ag₂Ga+zGa coating on non-metallic materials, forms a flexible and optionally transparent film with excellent electrical conductivity and mechanical compliance.

The coating may be applied by painting, spraying, rolling, or printing, followed by mild heat, vibration, or ultraviolet (UV) curing. The resulting films can function as the following:
1. Multi-layer flexible conductors that can be rolled, bent, or used as wiring materials in reconfigurable electronics.
2. Transparent conductive layers when applied in sub-micron thicknesses or controlled compositions.
3. Temporary conductive interfaces on graphite, concrete, or asphalt that can be easily removed or re-applied.

Thus, the present invention bridges the gap between metallic conductors and flexible polymeric materials, offering durable, low-cost, and easily processed conductive coatings for both industrial and consumer applications.

Although the invention has been explained in relation to its preferred embodiment, it is to be understood that many other possible modifications and variations can be made without departing from the spirit and scope of the invention as hereinafter claimed.

What is claimed is:

1. A method of applying a conductive coating, the method comprising the steps of:
(E) providing a treatable apparatus, wherein the treatable apparatus is made of a specific material;
(F) applying at least one silver-gallium film onto at least one specific exterior surface of the treatable apparatus; and
(G) curing or annealing the silver-gallium film onto the specific exterior surface in order to coat the specific exterior surface with a continuous conductive film.

2. The method as claimed in claim 1, wherein the specific material is an opaque material.

3. The method as claimed in claim 2, wherein the opaque material is selected from a group consisting of: polymer, carbon, wood, graphite, ceramic, concrete, asphalt, glass, and silicon.

4. The method as claimed in claim 1, wherein the specific material is a transparent or translucent material.

5. The method as claimed in claim 4, wherein the transparent or translucent material is selected from a group consisting of: glass and polymer.

6. The method as claimed in claim 1, wherein a chemical composition of the silver-gallium film is Ag₂Ga+zGa, and wherein a value of z is optimized between a range of 1 to 5.

7. The method as claimed in claim 1, wherein step (F) is executed by a coating process selected from a group consisting of: brushing, rolling, spraying, evaporation, sputtering, and electrochemical deposition.

8. The method as claimed in claim 1, wherein step (F) is executed by depositing a layer of Ag₂Ga nano-crystalline and micro-crystalline wires with an excess of gallium at normal temperature and pressure (NTP) onto the specific exterior surface.

9. The method as claimed in claim 1, the method further comprising the step of:
increasing a transparency of the continuous conductive film by decreasing a thickness of the silver-gallium film during step (F).

10. The method as claimed in claim 1, the method further comprising the step of:
executing a plurality of iterations for step (F), wherein the at least one silver-gallium film is a plurality of silver-gallium films, and wherein the plurality of silver-gallium films is layered onto each other during plurality of iterations for step (F).

11. The method as claimed in claim 1, wherein at least one physical property of the continuous conductive film is modified by adjusting at least one of process parameters during steps (F) and (G), wherein the process parameter is selected from the group consisting of: the value of z in Ag₂Ga+zGa, a thickness of the silver-gallium film, a kind of application method of the silver-gallium film during step (F), an annealing duration, an annealing temperature, and a combination thereof.
